(19) United States
(12) Patent Application Publication
(10) Pub. No.: US 2007/0088812 A1
(43) Pub. Date: Apr. 19, 2007

(54) MEDIA CONTROL SYSTEM

(76) Inventor: Christopher M. Clark, Knoxville, TN (US)

Correspondence Address: LUEDEKA, NEELY & GRAHAM, P.C., P O BOX 1871, KNOXVILLE, TN, 37901, US

(21) Appl. No.: 11/422,735

(22) Filed: Jun. 7, 2006

Related U.S. Application Data
(63) Continuation-in-part of application No. 11/253,195, filed on Oct. 18, 2005.
(63) Continuation of application No. 11/328,948, filed on Jan. 10, 2006.

(51) Int. Cl. G06F 15/173

(52) U.S. Cl. 709/223

(57) ABSTRACT

A media control computer system provides centralized access and distribution of digital media content. The system provides a user full control of multiple media sources from any television or video screen connected to the system. The system provides for storage and distribution of various types of media in practically any digital format, such as movies, television programs, music and video games. The system may be controlled wirelessly, such as using Bluetooth technology. The system may be expanded using expansion cards or chips that a user may install in one central location, thereby replacing the many “black boxes” of the typical home entertainment center. The system receives input from the Internet, cable/satellite television, peripheral devices and various types of media devices. Media output may be distributed to television screens and audio systems throughout a home, office or other location.

This application claims priority as a continuation-in-part to pending U.S. patent application Ser. Nos. 11/253,195 filed Oct. 18, 2005 and 11/328,948 filed Jan. 10, 2006.

### FIELD

This invention relates to the field of digital media systems. More particularly, this invention relates to a media control computer system for controlling distribution of media content over a network.

### BACKGROUND

In recent years, the number of sources and formats of entertainment and information media has increased dramatically. For example, motion pictures and television programs are available on satellite/cable television, the Internet, DVRs, DVDs and video tapes. Music is available on satellite radio, traditional radio, the Internet, CDs and audio tapes. In the past, accessing these various media sources has generally required a different “black box” or “set top box” for each source. To access satellite or cable television, one needed a satellite or cable receiver box. To access the Internet, one needed a personal computer with a modem or router. To play CDs and DVDs, one needed a disk player or personal computer. To access satellite radio, one needed a satellite radio receiver. To access all of these sources, one would need a substantial stack of “boxes,” plus the cables and wiring needed to connect the boxes to a television and audio system. To access these media sources in more than one room of a home has traditionally required a separate set of “black boxes” for each room and a separate set of controls for each room.

Controlling all of these boxes for the various media sources has required multiple remote controls or the programming of universal remote controls. Keeping track of these various remote controls in the home can be quite challenging.

What is needed, therefore, is a centralized and expandable media control system that combines the various “boxes” of the prior systems into a single integrated unit and that distributes the media content to various rooms of a home or office. Also, a single simple-to-use interface is needed for controlling access to the media and distribution of the media from the various sources.

### SUMMARY

The above and other needs are met by a media control computer system that provides centralized access and distribution of digital media content. The system provides a user full control of multiple media sources from any television or video screen connected to the system. The system provides for storage and distribution of various types of media in practically any digital format, such as movies, television programs, music and video games. The system may be controlled wirelessly, such as using Bluetooth technology. The system may be expanded using expansion cards or chips that a user may install in one central location, thereby replacing the many “black boxes” of the typical home entertainment center. The system receives input from the Internet, cable/satellite television, peripheral devices and various types of media devices. Media output may be distributed to television screens and audio systems throughout a home, office or other location.

In a preferred embodiment, the system includes a main controller computer for controlling distribution of the digital media content based on input received from a user of the system. The main controller computer is connected to a main bus over which information is communicated to and from the main controller computer. The system includes one or more television/computer interface devices which communicate with the main controller computer via the main bus. Each of the television/computer interface devices receives graphics information and generates video signals based at least in part on the graphics information. The video signals are in a format that is compatible for display on a television display device.

Preferred embodiments of the system include a media center device connected to the main bus for providing mass storage of the digital media content. The media center device includes one or more mass storage devices, such as optical drives, magnetic hard drives and flash memory drives, on which the digital media content is stored.

Preferred embodiments of the system also include a personal computer device connected to the main bus for executing software applications, generating graphics information based on execution of the software applications and providing the graphics information to the television computer interface device via the main bus. The television/computer interface devices receive the graphics information generated by the personal computer device and generate the video signal based at least in part on that graphics information.

The television/computer interface devices of the preferred embodiment may be disposed on one or more printed circuit cards that are operable to be inserted into interface slots in the main bus. The television/computer interface devices may also be provided in one or more semiconductor chips that plug into chip sockets on the printed circuit cards. The printed circuit cards may also include expansion sockets for receiving expansion chips, such as chips containing additional television/computer interface devices or additional personal computer devices.

The system preferably includes a network interface device connected to the main bus. The network interface device receives control signals and provides control information to the main controller computer based on the control signals. One or more control devices generate the control signals based on input received from the user of the system, and the control devices communicate the control signals to the network interface device. The control devices may be wired or wireless, and compatible with formats such as USB, Bluetooth, Wi-Fi, WiMAX and HyperLAN. In preferred embodiments, the network interface device receives peripheral signals from one or more wired or wireless peripheral devices, such as a Bluetooth-enabled cellular phone or a digital camera having a USB port.

In a most preferred embodiment, the system includes a direct bus router for routing direct connections between media output devices and media access devices under control of commands from the media control computer. The direct bus router includes multiple first connection ports for connecting to the media output devices, multiple second connection ports for connecting to the media access devices and switching means for connecting one or more of the first connection ports to one or more of the second connection ports.

In some preferred embodiments, the system includes an audio router connected to the main bus. The audio router routes audio signals to one or more sets of audio speakers connected to the audio router. The routing of the audio signals is preferably controlled by control signals generated by the media controller computer and provided to the audio router via the main bus.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a digital media interface system according to a preferred embodiment of the invention;

FIG. 2 depicts a television/computer interface portion of a digital media interface system according to a preferred embodiment of the invention:

FIG. 3 depicts a computer portion of a digital media interface system according to a preferred embodiment of the invention;

FIG. 4 depicts a digital media interface system according to an alternative embodiment of the invention;

FIGS. 5-7 depict a television/computer interface portion of a digital media interface system according to alternative embodiments of the invention;

FIG. 8 depicts further details of a digital media interface system according to a preferred embodiment of the invention;

FIG. 9 depicts a portion of an MPEG-2 digital media data stream according to a preferred embodiment of the invention;

FIGS. 10A-10C depict examples of television screen graphics generated by a digital media interface system according to a preferred embodiment of the invention;

FIG. 11 depicts a digital media interface system according to another alternative embodiment of the invention;

FIG. 12 depicts a method of operating a digital media interface system according to a preferred embodiment of the invention;

FIG. 13 depicts a media control system including a main controller computer according to a preferred embodiment of the invention;

FIG. 14 depicts a television/computer interface of the media control system according to a preferred embodiment of the invention;

FIG. 15 depicts the television/computer interface and a personal computer card of the media control system according to a preferred embodiment of the invention;

FIG. 16 depicts an interface controller of the television/computer interface of the media control system according to a preferred embodiment of the invention;

FIG. 17 depicts a graphics controller of the media control system according to a preferred embodiment of the invention;

FIG. 18 depicts a media router of the media control system according to a preferred embodiment of the invention;

FIG. 19 depicts an expansion card of the media control system according to a preferred embodiment of the invention;

FIG. 20 depicts a media center computer of the media control system according to a preferred embodiment of the invention;

FIG. 21 depicts a direct bus router of the media control system according to a preferred embodiment of the invention; and

FIG. 22 depicts a display router of the media control system according to a preferred embodiment of the invention.

### DETAILED DESCRIPTION

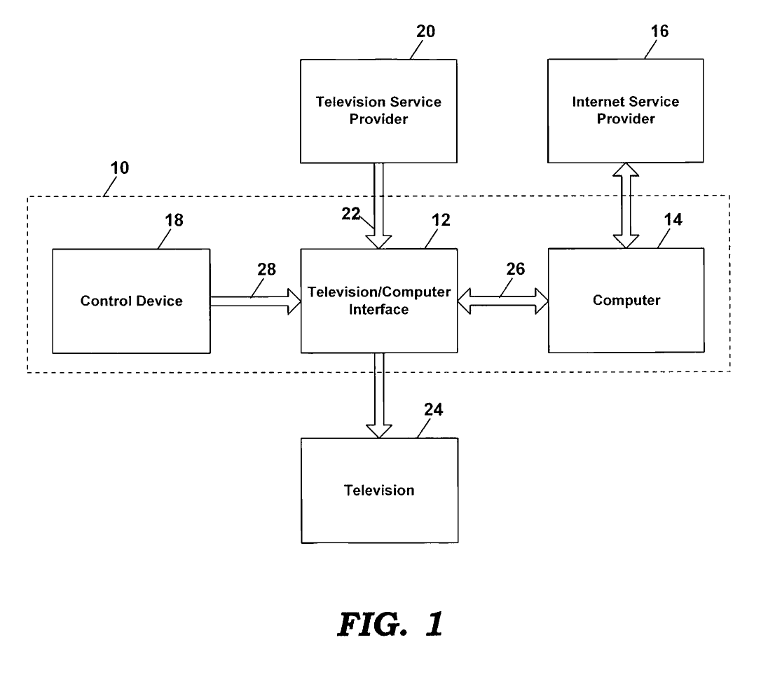

FIG. 1 depicts a preferred embodiment of a television interface system 10 according to the present invention. The system 10 includes a television/computer interface 12, a computer 14 connected to the Internet 16 and one or more remote control devices 18. The television/computer interface 12, which is also referred to herein as a set-top box (STB), receives a digital media signal from a television service provider 20, such as a satellite or cable television provider. The digital media signal is provided to the STB 12 via a connection 22 which may comprise a coaxial cable, an Ethernet connection, wireless signal or other means of signal transfer. As described in more detail hereinafter, the STB 12 decodes the digital media signal and provides it to a television viewing unit 24, such as a CRT, LCD or plasma monitor or a projector.

The STB 12 also receives a digital information signal from the computer 14 via a connection 26, which may be a wired or wireless local area network. Universal Serial Bus (USB) or direct bus connections, such as PCI. According to preferred embodiments of the invention, the STB 12 combines the digital information signal from the computer 14 with the digital media signal from the television service provider 20 to form a combined graphics signal. This combined signal is then provided to the television viewing unit 24.

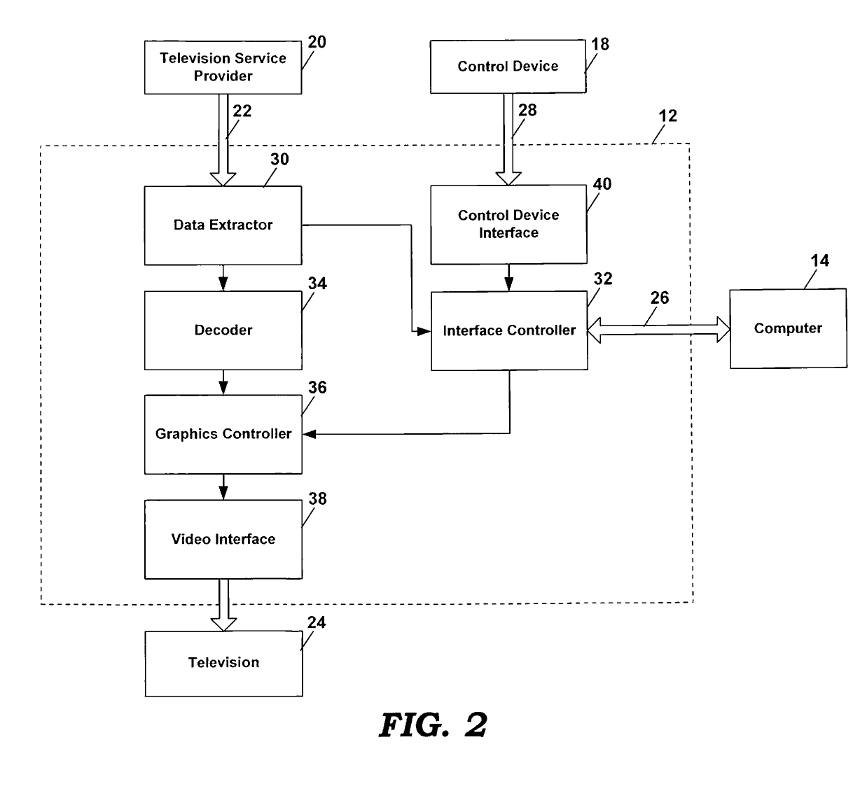

FIG. 2 depicts components of the STB 12 according to a preferred embodiment of the invention. The STB 12 includes a data extractor 30 that receives the digital media stream from the television service provider 20. Embedded in the digital media stream is “user data,” also referred to herein as “consumer-oriented data.” The purpose of the data extractor 30 is to extract or copy the user data and provide it to the computer 14.

User data may be present in the digital media stream 22 for various purposes, such as to identify the source of the associated video program or the particular type of software that was used to produce or encode the video data. As described in more detail hereinafter, user data may also be used to provide information to consumers regarding products or services depicted in the associated video program.

The user data is typically embedded in a user data section of the digital media stream. As described in more detail below, the data extractor 30 monitors the encoded digital media stream and “listens” for the beginning of a user data section. When a user data section is detected, the data extractor 30 copies the user data from the encoded data stream and passes it to an interface controller 32. The interface controller 32 sends the copied data from the data extractor 30 to the computer 14 over the connection 26. Although the user data is copied from the digital media stream as it passes through the data extractor 30, the digital media stream that enters the STB 12 on the connection 22 passes through the data extractor 30 substantially unaltered.

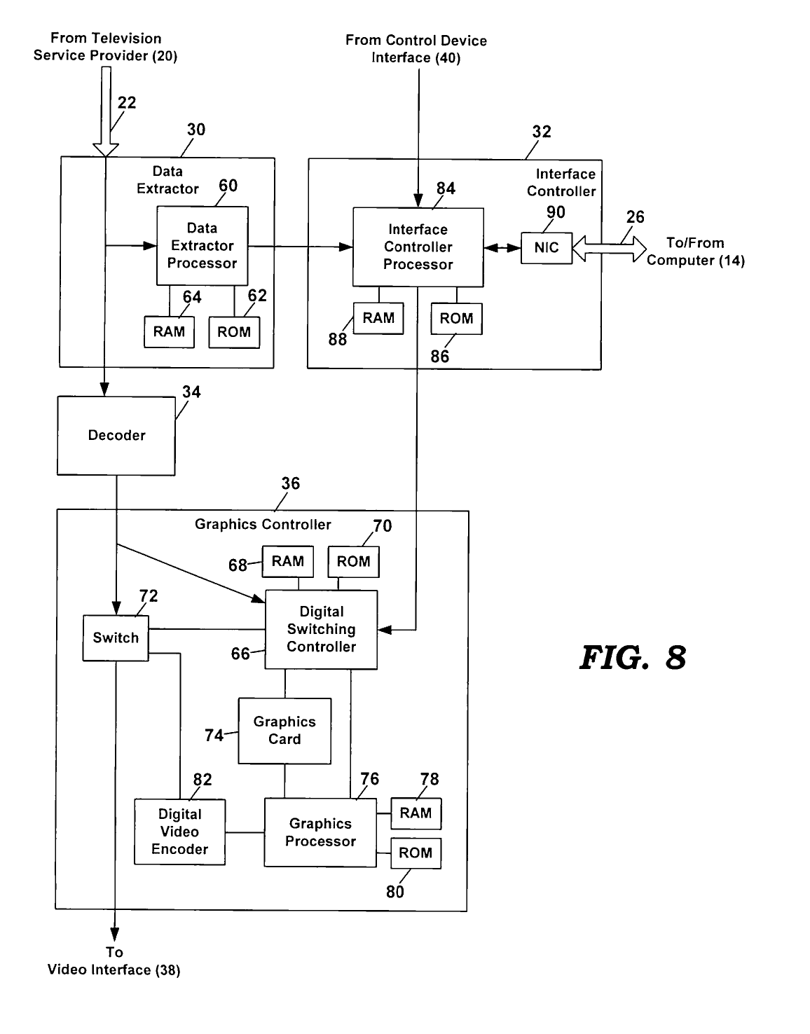

In preferred embodiments of the invention, the data extractor 30 functions as a listening port patched onto the digital media data stream 22. As shown in FIG. 8, the data extractor 30 includes a data extractor processor 60 that monitors the data stream 22 for sequences of the user data in the digital media signal. The data extractor 30 also include read-only memory (ROM) 62 for storing programming instructions and random access memory (RAM) 64 for temporary storage of data.

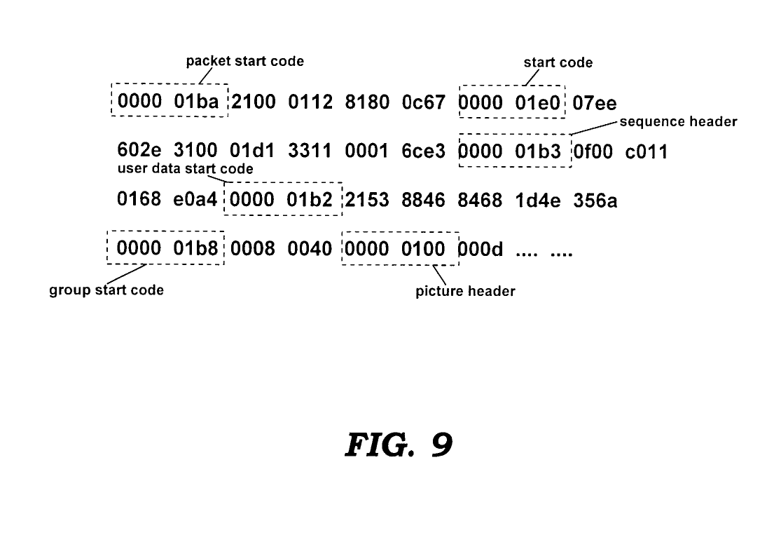

To provide background for describing the operation of the data extractor 30, the data format of an MPEG-2 data stream is first described with reference to FIG. 9, which represents typical MPEG-2 data in hexadecimal format. As shown in FIG. 9, an MPEG-2 data stream may include a number of different “start codes” that indicate the beginning of various portions of the data stream. According to the MPEG-2 standard for digital video as set forth in ISO/IEC 13818-2, start codes are specific bit patterns that do not otherwise occur in the video stream. Each start code consists of a start code prefix followed by a start code value.

According to the MPEG-2 standard, the start code prefix is a string of twenty three bits with the value of zero followed by a single bit with the value one. Thus, the start code prefix is the bit string “0000 0000 0000 0000 0000 0001” (0000 01 in hexadecimal). Immediately following the start code prefix is the start code value. The start code value is an eight bit integer that identifies the type of start code. Most types of start code have just one start code value.

The start code value for the “user data” portion of the MPEG-2 stream is “b2” in hexadecimal. Thus, as shown in FIG. 9. the hexadecimal value for the user data start code is “0000 01b2.” The actual user data comprises all the data in the data stream that follows the user data start code and precedes a stop code (or the next start code). The user data section can be of any length. In the example of FIG. 9, the user data comprises the string “2153 8846 8468 1d4e 356a.”

The SMPTE Registration Authority, LLC is currently authorized by the International Organization of Standardization (ISO) to register MPEG-2 format identifiers. The registration descriptor of MPEG-2 standard is provided by ISO 13818-1 to enable users of the MPEG-2 standard to unambiguously carry data when the format of the data is not necessarily a recognized international standard. This provision permits the MPEG-2 video transport standard to carry various types of data while providing for a method of unambiguous identification of the characteristics of underlying private data.

Entities that are registered with SMPTE are assigned a unique code that can be recognized in the video stream. Using this registration code, a registered entity can embed specific user data in the video data stream. The registration code can also be used to locate and extract the user data.

With reference to FIG. 8, the data extractor processor 60 listens for the user data start code (0000 01B2) in the MPEG-2 data stream Based on programming instructions stored in the ROM 62. Once the user data start code is detected, the processor 60 jumps to another section of programming in the ROM and begins listening for an appropriate registration code. When the registration code is detected, the processor 60 begins copying all the preceding data into the RAM 64 until a stop code is detected. The processor 60 forwards the data saved in the RAM 64 to the interface controller 32. The processor 60 then recycles and begins listening for the next user data start code.

After the video stream passes through the data extractor 30, a decoder 34, such as an MPEG-2 or MPEG-4 decoder, decodes the digital media stream into a pure digital luminance/chrominance (Y/C) signal. The decoded media signal is provided to a graphics controller 36 which combines the media stream data with graphics data from the computer 14, if it is instructed to do so. Finally, depending again on the application of the STB 12 and the type of television viewing device 24 in use, the digital media signal may be converted into an analog signal in a video interface 38. Thus, depending on the particular embodiment of the invention, the signal provided to the television viewing device 24 may be component video, composite video, Digital Visual Interface (DVI), High-Definition Multimedia Interface (HDMI) or other video or multimedia format.

As discussed in more detail hereinafter, the computer 14 sends graphics data and commands via the connection 26 to the interface controller 32. The interface controller 32 relays the graphics data from the computer 14 to the graphics controller 36. The graphics controller 36 embeds the graphics data from the computer 14 into the original digital media stream that passed through the data extractor 30. The graphics controller 36 also develops the appropriate graphics for display on the television viewing device 24 based on the combined digital media and computer graphics signals.

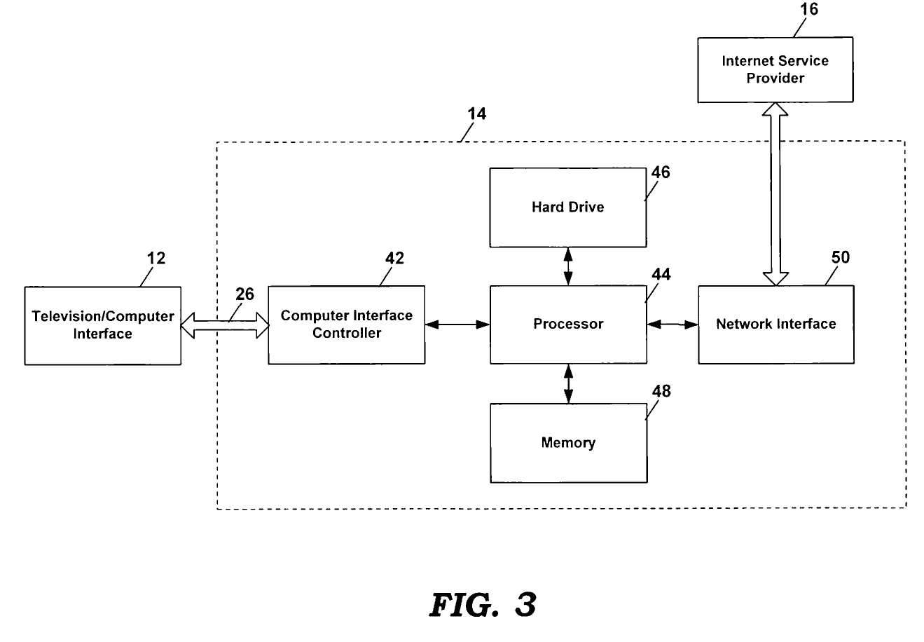

FIG. 3 depicts a preferred embodiment of the computer 14, which comprises a computer interface controller 42, a processor 44, a hard drive 46, memory 48 and a communication network interface 50. The interface controller 42 may be a local area network interface card, a USB controller or an address/data bus, such as a PCI bus. The interface controller 42 provides the data interface between the STB 12 and the processor 44.

Using the hard drive 46 and the memory 48, the processor 44 processes the data from the STB 12 depending on the type of data received. If the data is a request for an Internet link to be shown on the television display device 24, the processor 44 uses browser software to fetch the requested link data via the network interface 50. Based on the link data, the processor 44 generates graphics instructional data and provides the graphics instructional data to the computer interface controller 42 to be sent to the STB 12 via the connection 26.

The interface controller 32 of the STB 12 receives the graphics instructional data from the computer interface controller 42 and provides this data to the graphics controller 36. As described in further detail below, the graphics instructional data provides information to the graphics controller 36 regarding how to display the link information that was requested. Based on the graphics instructional data, the graphics controller 36 develops the appropriate link graphics and embeds the link graphics into the digital video stream. For example, the link graphics may comprise a computer “window” displaying a web page corresponding to the link information. This window is shown on the television display device 24 as an overlay on the original digital video signal. In the preferred embodiment, the overlaid computer window appears on the display device 24 the same manner as it would in a browser window displayed on a computer screen.

As shown in FIG. 8, the interface controller 32 includes an interface controller processor 84 that is in communication with to the control device interface 40, data extractor 30 and graphics controller 36. The control device interface 40 and the data extractor 30 provide data to the processor 84 which operates on the data based on instructions stored in the ROM 86. These instructions determine how the processor 84 is to modify the input data so that it can be sent to the network interface card (NIC) 90 and on to the computer 14 in a format that can be understood by software running on the computer 14. After the data is modified appropriately, it is stored to the RAM 88 until it is sent to the NIC 90.

Preferably, these operations work in the same manner in reverse. When the NIC 90 receives data from the network 26, it sends the data to the processor 84. The processor 84 then uses instructions from the ROM 86 to modify the data appropriately to send it on to the graphics controller 36. The modified data is then stored in the RAM 88 until the proper time to be forwarded to the graphics controller 36.

As shown in FIG. 8, the graphics controller 36 provides a system for generating graphics and embedding them synchronously into the digital media stream. In a preferred embodiment of the invention, the graphics controller 36 includes a digital switching controller 66 with associated RAM 68 and ROM 70, a data switch 72, graphics card 74, graphics processor 76 with associated RAM 78 and ROM 80, and a digital video encoder 82.

In the preferred embodiment, the digital switching controller 66 receives its instructions from the interface controller 32 and divides those instructions into graphics instructions and embedding instructions. The digital switching controller 66 forwards the graphics instructions to the graphics card 74 and saves the embedding instructions in RAM 68.

The digital switching controller 66 is also responsible for monitoring the digital media signal that passes through the data extractor 30, preferably in the same manner as the data extractor 30 monitors the digital media signal 22. The digital switching controller 66 monitors the digital media signal for the appropriate location in the data stream to activate the switch 72 to allow graphics to be embedded in the stream. This embedding location is determined based on the embedding instructions that were stored in RAM 68. In a normal mode, the switch 72 allows the digital media signal to pass unaltered. When the switch 72 receives appropriate instructions from the digital switching controller 66, the switch 72 is operated in a graphics insertion mode wherein graphics created in the graphics processor 76 are synchronously inserted into the video stream. In the preferred embodiment, this synchronous switching is accomplished using switching logic gates in the switch 72. An example of a similar switching scheme is that used in cable or satellite set-top boxes to insert programming guide graphics into a video signal along with an incoming video program signal.

In the preferred embodiment, the graphics card 74 operates in the same manner as graphics cards used in personal computers. The graphics card 74 receives the graphics instructions from the digital switching controller 66 in a format which is the same as, or very similar to, the format such instructions would be provided by a personal computer. Thus in the preferred embodiment, the graphics card 74 perceives that the graphics instructions came directly from the computer 14.

Based on the graphics instructions from the digital switching controller 66, the graphics card 74 outputs the graphics data that the graphics processor 76 copied to its RAM 78. The graphics processor 76 then waits for a signal from the digital switching controller 66 that it is time to embed the graphics data into the digital media signal. When the digital switching controller 66 tells the graphics processor it is time to embed the graphics data, it either tells the graphics processor 76 how much data it is going to embed or it tells the graphics processor 76 when to stop.

When the graphics processor 76 is instructed to embed the graphics data, it outputs the data to the digital video encoder 82 which converts the data to the appropriate video format. For example, if the graphics card 74 created the graphics data in RGB format, the digital video encoder 82 converts the data into digital video luminance/chrominance (Y/C) format. The digital video encoder 82 then outputs the data to the switch 72 which embeds the graphics data into the digital media signal.

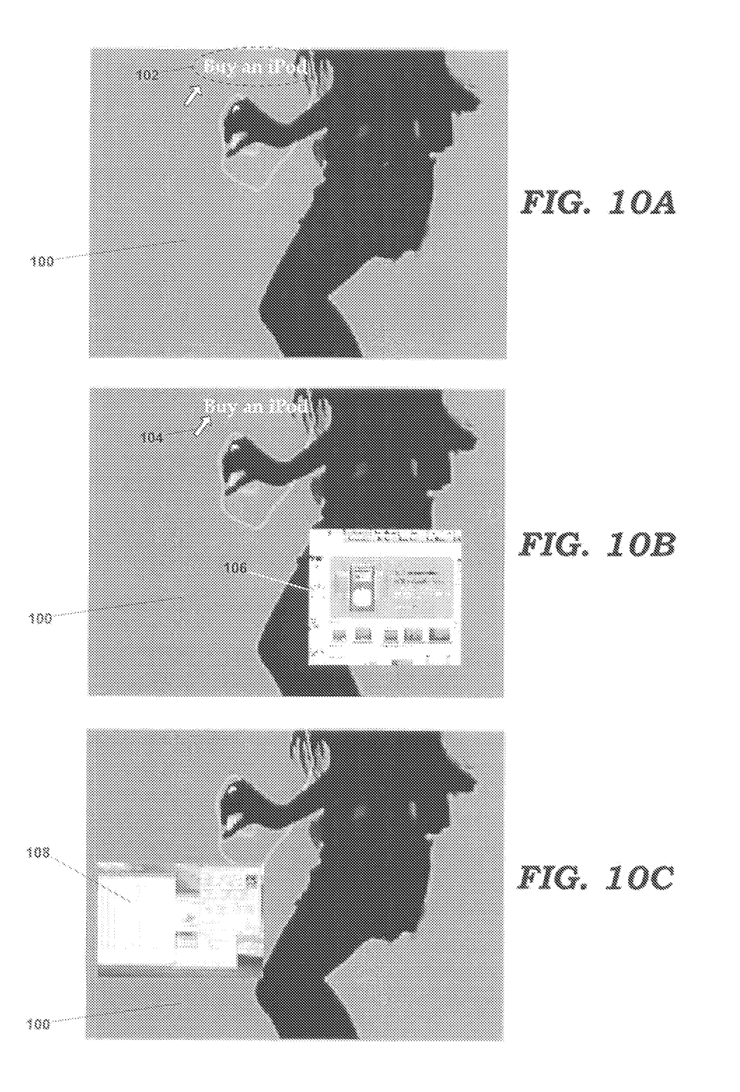

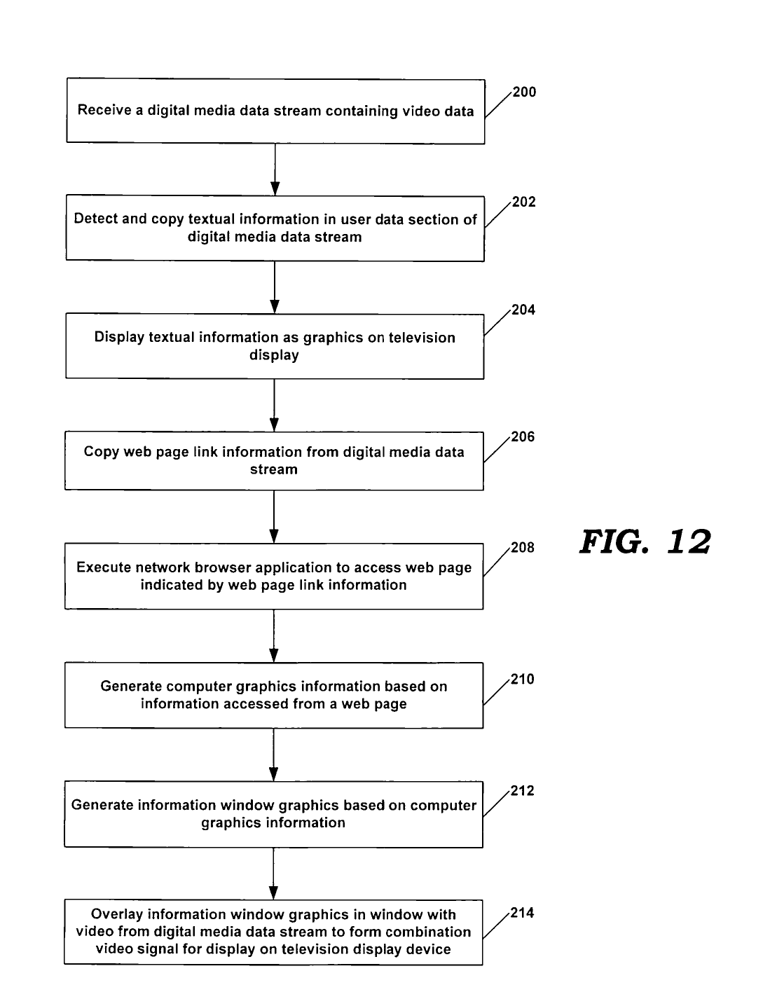

FIGS. 10A and 10B depict an example of television screen graphics generated by a preferred embodiment of the invention. FIG. 12 depicts steps performed in generating the screen graphics of FIGS. 10A and 10B. As shown in FIG. 10A, while receiving a video data stream depicting a television advertisement 100 for an Apple IPod (step 200 in FIG. 12), the data extractor 30 detects and copies user data in the video data stream that includes the textual phrase “Buy an iPod” (step 202). Based on this user data, the graphics controller 36 generates a graphical representation of the same textual phrase and embeds it in the digital media signal as described previously. As a result, the graphical representation 102 of “Buy an iPod” appears on the television display along with the video information for the television advertisement 100 (step 204).

In this example, the user data detected by the data extractor 30 also includes link information about a website where a consumer may obtain further information and/or purchase an iPod. This link information may be provided as a URL or an IP address. When detected, the link information is copied and sent to the interface controller 32 which provides the information to the computer 14 (step 206).

When a user sees the text graphics 102 appear on the television screen, this indicates to the user that further information regarding the advertised product is available on the Internet. To access that product information, the user presses a button on a remote control device 18 (see FIG. 2) to activate the interface controller 32 to send a request signal to the computer 14. In response to the request signal, the computer 14 accesses the associated web site, such as using a browser application (step 208). In an alternative embodiment, the user may use a mouse, touch pad or remote control, to position a curser 104 to click on the text graphics 102 which activates the interface controller 32 to send the request signal to the computer 14.

Continuing the example of FIGS. 10A and 10B, the computer 14 then accesses the web site and provides graphic information for generating the web page to the interface controller 32 (step 210). As described above, the interface controller 32 provides the web page graphics information to the graphics controller 36 which embeds the web page graphics into the digital media stream (step 212). As shown in FIG. 10B, the web page then appears in a Window 106 on the television display device (step 214). Using the control device 18, the interactive functions provided in the web page window 106 may then be accessed in the same manner as if the web page were being viewed on a computer display connected directly to the computer 14. At the same time, the video program 100 continues on the television display “behind” the window 106.

According to a preferred embodiment of the invention, the graphical “relay” provided by the interface controller 32 and the graphics controller 36 also allows a user to view on the television display device 24 the graphics generated by any computer application running on the computer 14. In this manner, the user may take advantage of all the computer's functionality from in front of the television display device 24, such as word processing or email applications, or a full desktop environment. FIG. 10C depicts an example of the computer desktop displayed in a window 108 as a video program 100 continues on the television display “behind” the window 108.

In the preferred embodiment of the invention, the control device 18 comprises one or more USB control devices, such as a keyboard, touchpad, mouse, remote control or other user interface unit used to control the functionality of the STB 12 or the computer 14 or both. In the preferred embodiment, the control device 18 includes a USB keyboard and mouse. The control device 18 communicates via a connection 28 with a control device interface 40 in the STB 12. The connection 28 may be either wireless, such as infrared or RF, or wired. The control device interface 40 provides the control commands to the interface controller 32 which communicates the commands to the computer 14. Interface software running on the computer 14 allows the control device 18 to function with the computer 14 as if it was connected directly to the computer. Commands from the control device 18 can also trigger graphics to appear on the television display device 24.

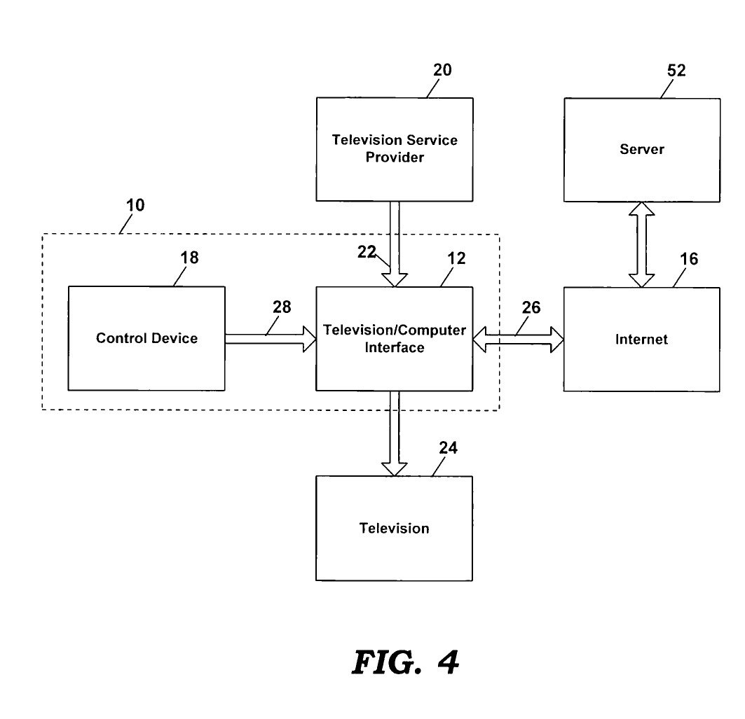

In an alternative embodiment of the invention depicted in FIG. 4, instead of being connected to a personal computer over a local area network, the STB 12 is connected to an off-site server computer 52 over a communication network 54, such as the Internet or a virtual private network. In this embodiment, the connection 26 is an Internet or VPN connection to a cable modem in the interface controller 32 of the STB 12. The server 52 provides many of the same services as provided by the computer 14 of the embodiment depicted in FIGS. 1, 2 and 3. In this alternative embodiment, however, the server 52 provides access to the Internet and email for users that do not have a personal computer.

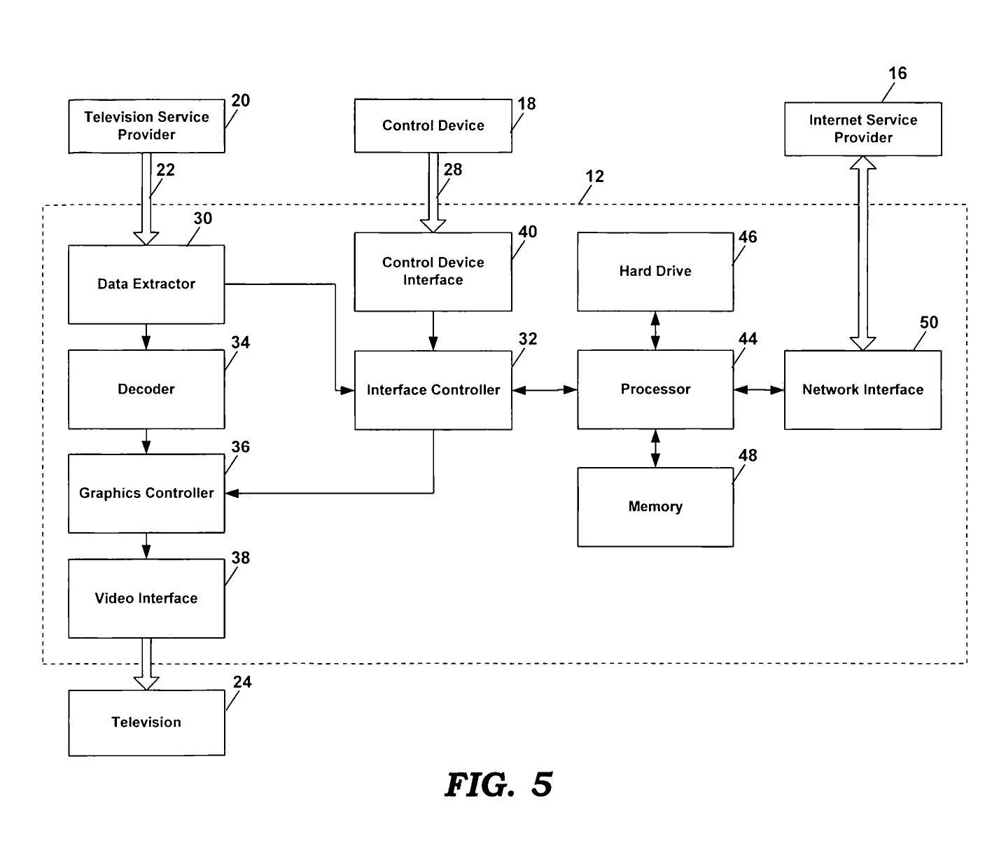

In another alternative embodiment of the invention, the components of the computer 14 are incorporated into the STB 12. As shown in FIG. 5, the processor 44 of this embodiment communicates directly with the interface controller 32, such as via a PCI bus. Otherwise, this embodiment functions in the same manner as the system depicted in FIGS. 1, 2 and 3.

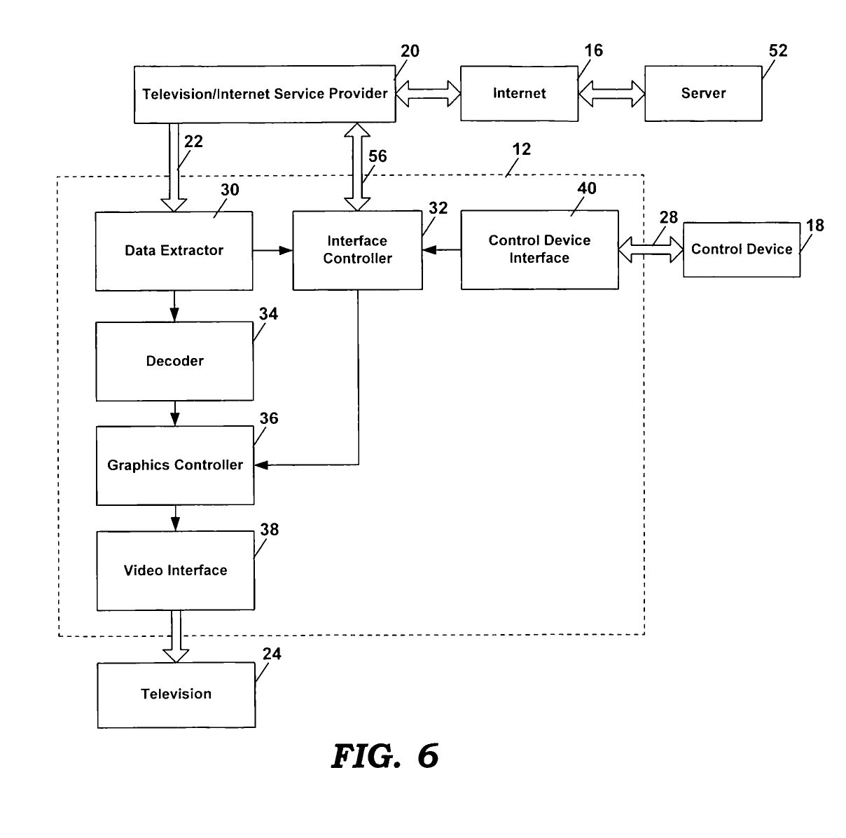

In another alternative embodiment depicted in FIG. 6. the interface controller 32 of the STB 12 accesses the Internet via a two-way interface provided by the television service provider, such as through a cable or satellite modem connection 56. In this embodiment, the interface controller 32 connects to the television service provider 20 which provides an Internet or VPN connection to an off-site server 52.

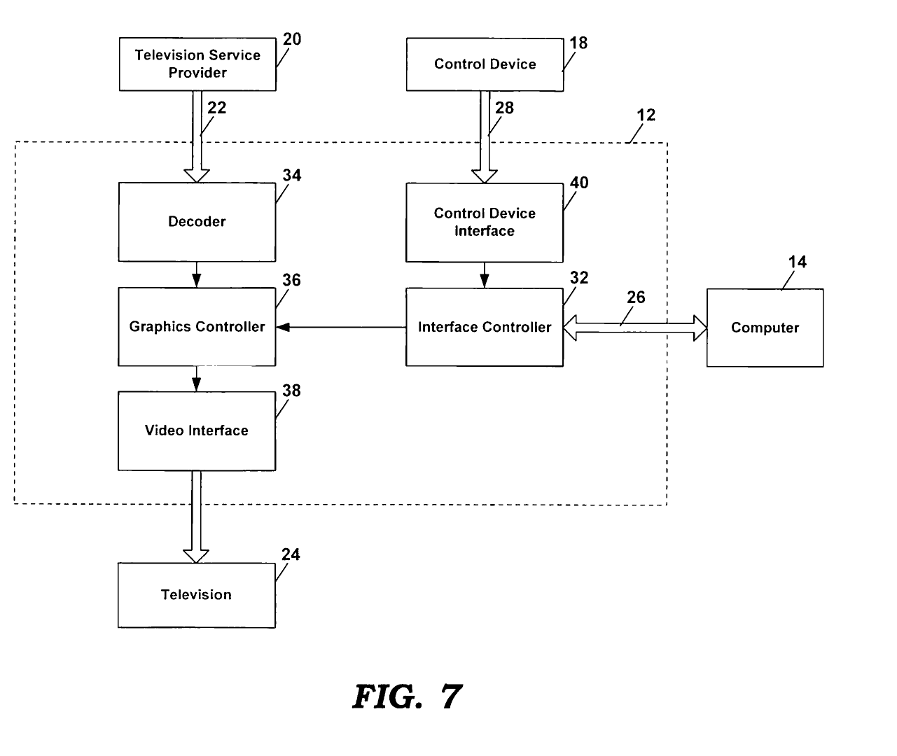

Yet another embodiment of the invention is depicted in FIG. 7. This embodiment functions in substantially the same manner as the embodiment of FIG. 2 except that no consumer oriented data is extracted from the digital media stream. Thus, any graphics the user chooses to display in the window overlaid on the screen of the display device 24 is not necessarily related to any consumer information in the digital media stream.

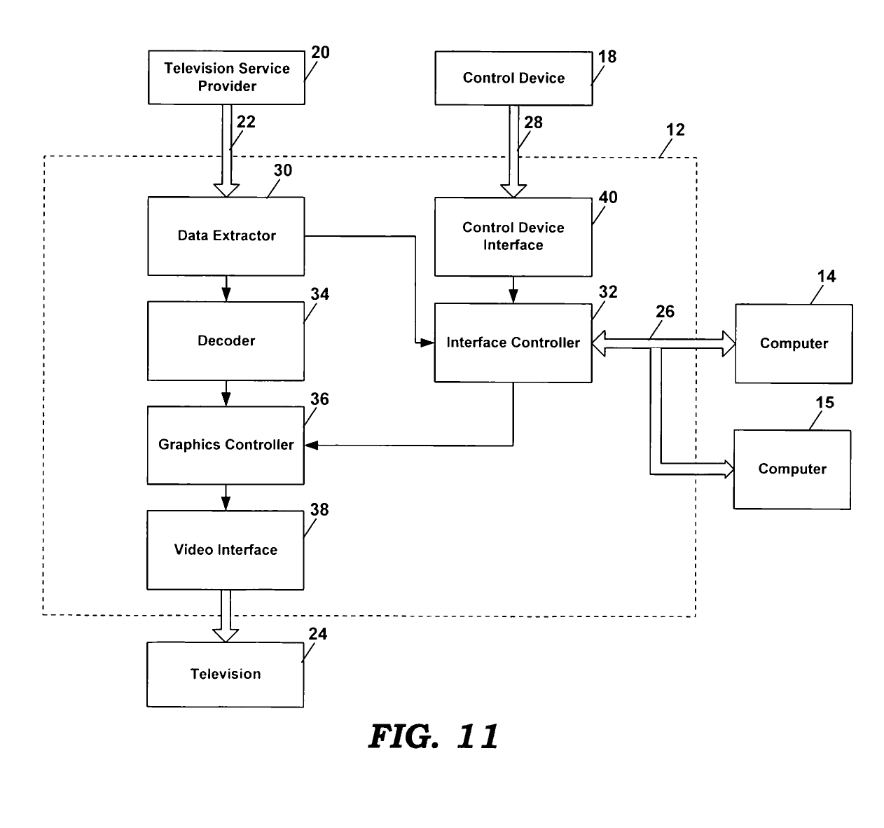

In an embodiment of the invention depicted in FIG. 11, the computer 14 is in communication with a second computer 15, such as a portable laptop computer, so that the computer 14 can send the website data to the second computer 15. For example, using the embodiment of FIG. 11, a user may be watching a television program while surfing the web on the computer 15 at the same time. When link graphics, such as the graphics 102 in FIG. 10A, appear on the television and the user clicks on the link graphics 102 using the interface device 18, instead of displaying the web page on the television, the web page is displayed on the screen of the second computer 15. This function may be activated as an option that is selected in an on-screen setup menu provided on the television screen. In this embodiment, the computer 15 is running application software that can respond to the requests and information from television/computer interface 12. Thus, the computer 15 can send and receive data to and from the computer 14 and the television/computer interface 12.

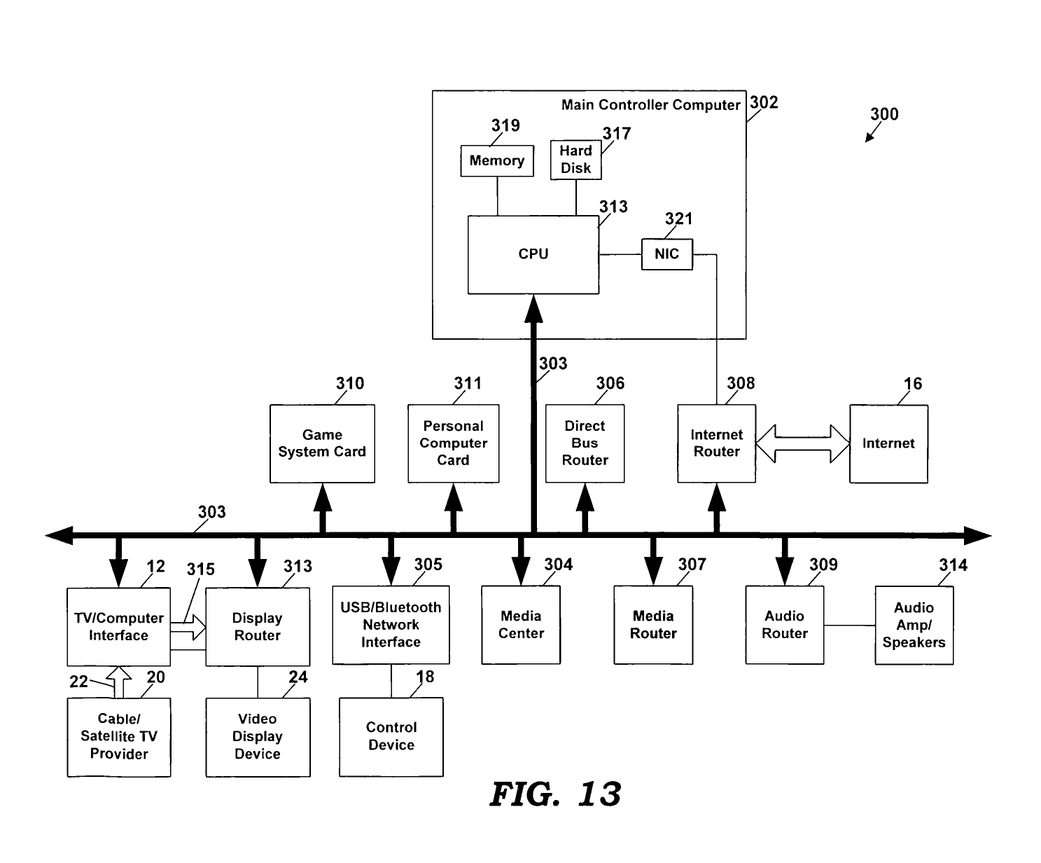

In a preferred embodiment of the invention depicted in FIG. 13, the television/computer interface 12 is one component of a media control system 300. As described herein, the system 300 provides a user full control of multiple media sources from any video screen connected to the system 300. The system 300 provides for storage of and access to media in practically any digital format, such as movies, television programs, music and video games. In preferred embodiments, the system 300 may be controlled wirelessly, such as using Bluetooth technology. The system 300 may be expanded using expansion cards or chips that a user may install in one central location. In this manner the system 300 eliminates the proliferation of “black boxes” that tend to pile up in home entertainment centers and in several rooms throughout a home. Inputs to the system 300 include, but are not limited to the Internet, cable/satellite television, Bluetooth, peripheral devices, media devices, voice-over-Internet protocol (VoIP) and universal serial bus (USB). Outputs from the system 300 include audio, video, Bluetooth, Ethernet (WAN or LAN), VolP and USB.

As shown in FIG. 13, the media control system 300 includes a Main Controller Computer (MCC) 302 which controls all processes in the system 300. The MCC 302 is connected to every other component of the system 300 via a main address/data/control bus 303, such as a PCI bus, a PCI-X bus or PCI Express bus, as may be found in a computer motherboard. In the preferred embodiment, the MCC 302 includes a hard disk drive 317 and memory 319 for storage of programs executed by a processor 313. The MCC 302 includes a network interface card (NIC) 321 which allows the MCC 302 to connect to the Internet 16 via an Internet router 308. Preferably, the MCC 302 may also access the Internet 16 through the Internet router 308 by way of the main bus 303 to which the router 308 is also connected.

In the preferred embodiment shown in FIG. 13, the MCC 302 is connected via the main bus 303 to ten cards, which number may be expanded upon as described hereinafter. The cards include a TV/computer interface card 12, media center card 304, USB/Bluetooth network interface card 305, direct bus router card 306, media router card 307, Internet router card 308, audio router card 309, game system card 310, personal computer card 311 and display router card 313. The functions of each of these cards are discussed in more detail hereinafter.

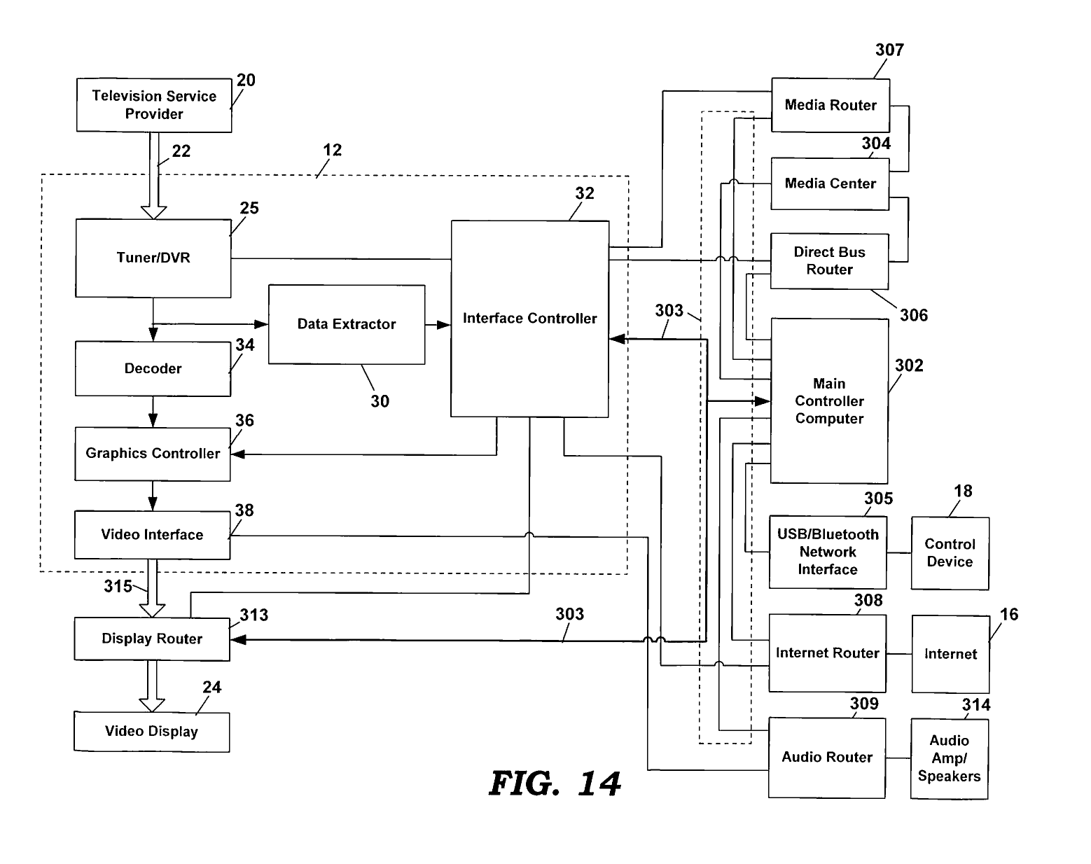

FIG. 14 provides a more detailed depiction of the connection of the TV/computer interface 12 within the system 300. In the preferred embodiment, the TV/computer interface 12 is responsible for all video output for the system 300, providing video output to the display router 313 by way of the display bus 315. As described in more detail below. the display router 313 routes the video output to one or more video display devices 24. As shown in FIG. 14, TV/computer interface 12 of this embodiment includes a tuner/digital video recorder (DVR) 25, decoder 34, graphics controller 36, video interface 38, data extractor 30 and interface controller 32. Generally, the TV/computer interface 12 of this embodiment functions in the same manner as the embodiments described above, with some differences. For example, in the embodiment of FIG. 14, the interface controller 32 receives inputs from the media router 307, the direct bus router 306 and the Internet router 308. The interface controller 32 connects directly to the MCC 302 via the main bus 303. The interface controller 32 also connects to other of the devices, such as the media center 304 and the PC card 311, via the media router 307 or the direct bus router 306.

As shown in FIG. 14 the tuner/DVR 25 is connected to the interface controller 32 so that the media controller computer 302 can control the tuner/DVR 25 by commands sent through the interface controller 32. This also provides for control of the tuner/DVR 25 using the control devices 18. This connection also allows transfer of recorded television programs from the tuner/DVR to the media center 304 for storage.

The MCC 302 receives requests from a control device 18 or other peripheral device 19 through the interface device 305, which may be a USB interface or a Bluetooth interface. Based on these requests, the MCC 302 determines what media is to be displayed and where it is to be displayed, and it sends commands across the main bus 303 to the devices involved in accessing, processing and displaying the requested media.

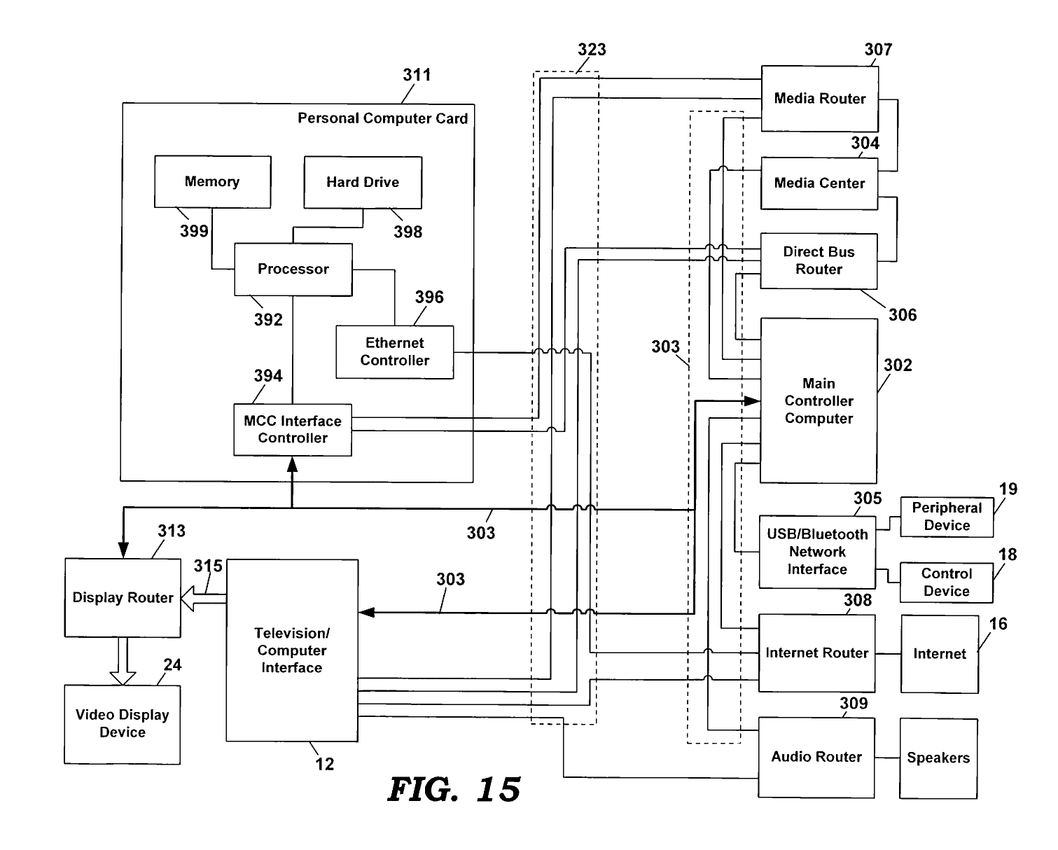

For example, with reference to FIG. 15, consider a situation wherein a home user wishes to run an application on the PC card 311 while viewing and controlling the application using a video display device 24 and control device 18 located in the user's living room. The video display device 24 of this example may be a television set and the control device 18 may comprise a USB keyboard/mouse. The user selects the application using the control device 18 which sends commands via the network interface 305 to the MCC 302. Based on the commands from the control device 18, the MCC 302 performs several actions, including (1) sending commands to the PC card 311 instructing it to send its output to the media router 307, (2) sending commands to the media router 307 instructing it to route output from the PC card 311 to the TV/computer interface card 12 and output from the TV/computer interface card 12 to the PC card 311, and (3) sending commands to the TV/computer interface card 12 instructing it to be awaiting connection to the PC card 311. The MCC 302 also sends commands to the network interface 305 instructing it to route connections from the control device 18 and/or the peripheral device 19 to the PC card 311. Also, the MCC 302 tells the display router 313 to which video display device to direct the output signal.

As shown in FIG. 15, the PC card 311 includes the same basic components as would be included in any personal computer. These components include a processor 392, memory 399 and hard drive 392. The PC card 311 includes an Ethernet controller 396 for connecting to the Internet 16 or other network by way of the Internet router 308. The PC card 311 also includes an MCC interface controller 394 which functions in much the same way as the interface controller 32 of the TV/computer interface 12. One difference between the controller 394 and the controller 32 is the fact that the controller 394 is programmed to communicate with the processor 392.

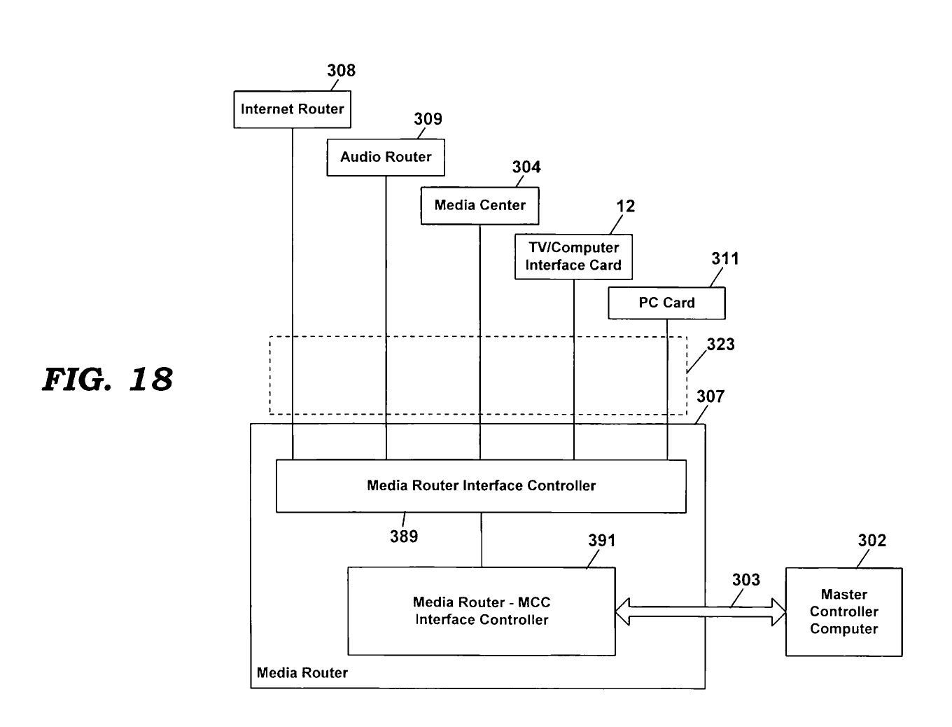

As shown in FIG. 18, the media router 307 routes connections through the router bus 323 from one device to another within the system 300. The media router 307 includes a media router interface controller 389 that establishes the connections between the various devices. Based on commands from the MCC 302, a media router/MCC interface controller 391 instructs the media router interface controller 389 to establish a connection between one device, such as the PC card 311, and another device, such as the TV/computer interface card 12. In a preferred embodiment, the media router interface controller 389 is also capable of performing the functions of the data extractor 30 described above in extracting or copying user data from the digital media data stream.

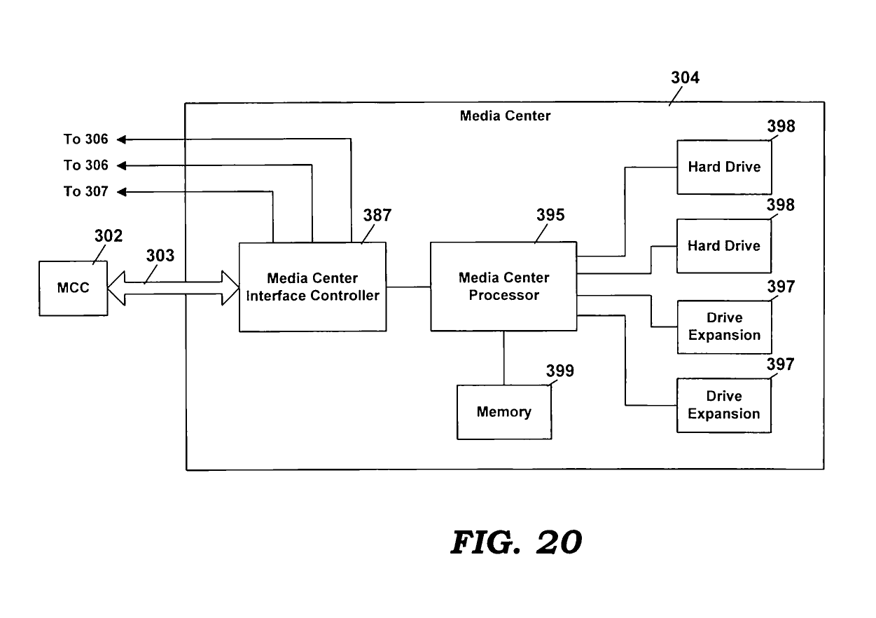

As shown in FIG. 20, the media center 304 provides the bulk of the media mass storage for the system 300. The media center 304 includes mass storage devices such as hard drives 398 for storing the digital media, which may include recorded television shows, movies, photos, music and audio books. Using the system 300, any of this media may be shown or played on any or all of the display devices and audio speakers connected to the system 300. The media center 304 also provides expansion slots or sockets 397 for adding more drives as needed. The drives 398 may be used for partitions, backups and basic mass storage.

With continued reference to FIG. 20, the media center 304 includes a processor 395, memory 399 and a media center interface controller 387. In the preferred embodiment, the media center interface controller 387 functions in much the same way as the MCC interface controller 394 in the PC card 311. However, the media center interface controller 387 preferably has two connections between the media center 304 and the direct bus router 306. As described in more detail below, this allows the media center 304 to connect with more than one TV/computer interface card 12 and other types of expansion cards.

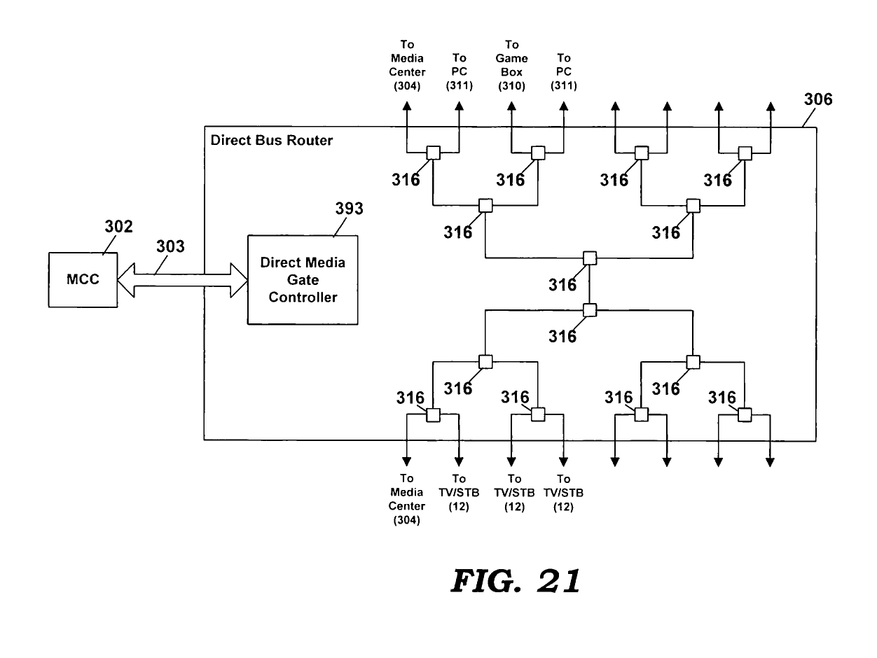

FIG. 21 depicts a preferred embodiment of the direct bus router 306. The direct bus router 306 provides a direct connection between two devices, thereby avoiding the use of a relay controller, such as the media router interface controller 389 (FIG. 18), between the two devices. This allows the two devices to interact as if they were directly hardwired together. The direct connection provided by the direct bus router 306 may be used in situations where the media router 307 is not fast enough to keep up with the data transfer rate, such as when transferring high-speed graphics data or large data files.

As shown in FIG. 21, the direct bus router 306 connects two devices together through a series of logic gates 316 arranged in a “tournament bracket” configuration. With this arrangement, any device on one side of the “bracket” may connect to any device on the other side. The logic gates 316 are controlled by a direct media gate controller 393 which receives instructions from the MCC 302. In the preferred embodiment, output devices, such as the PC card 311 and game system card 310, are connected to one side of the “bracket”, and display devices, such as the TV/computer interface cards 312, are connected to the opposite side. As shown in FIG. 21, the media center 304 is preferably connected to both sides, since it relays information to the output devices and to the display devices. In this design one bracket allows for one connection between two devices, to allow for more connections, a stack of brackets would be needed.

In the preferred embodiment of the invention, the TV/computer interface cards 12 provide audio output to the audio router 309. The video interface 38 of the TV/computer interface 12 preferably generates audio signals for programs having surround sound, such as Digital Theater Sound (DTS) or Dolby Digital signals. The MCC 302 provides instructions via the main bus 303 to the audio router 309 instructing the router 309 regarding the destination of the audio signals. In the case of a TV program or movie, the audio signals will typically be directed to an audio amplifier and speakers in the same room where the video portion of the TV program or movie is being displayed. However, it will be appreciated that the audio router 309 may direct the audio signals to any set of speakers connected to the system, as determined by commands sent from the MCC 302. The audio router 309 may be hardwired to the amplifier/speakers such as via a fiber optic cable, wirelessly connected, or connected via the network interface card 305.

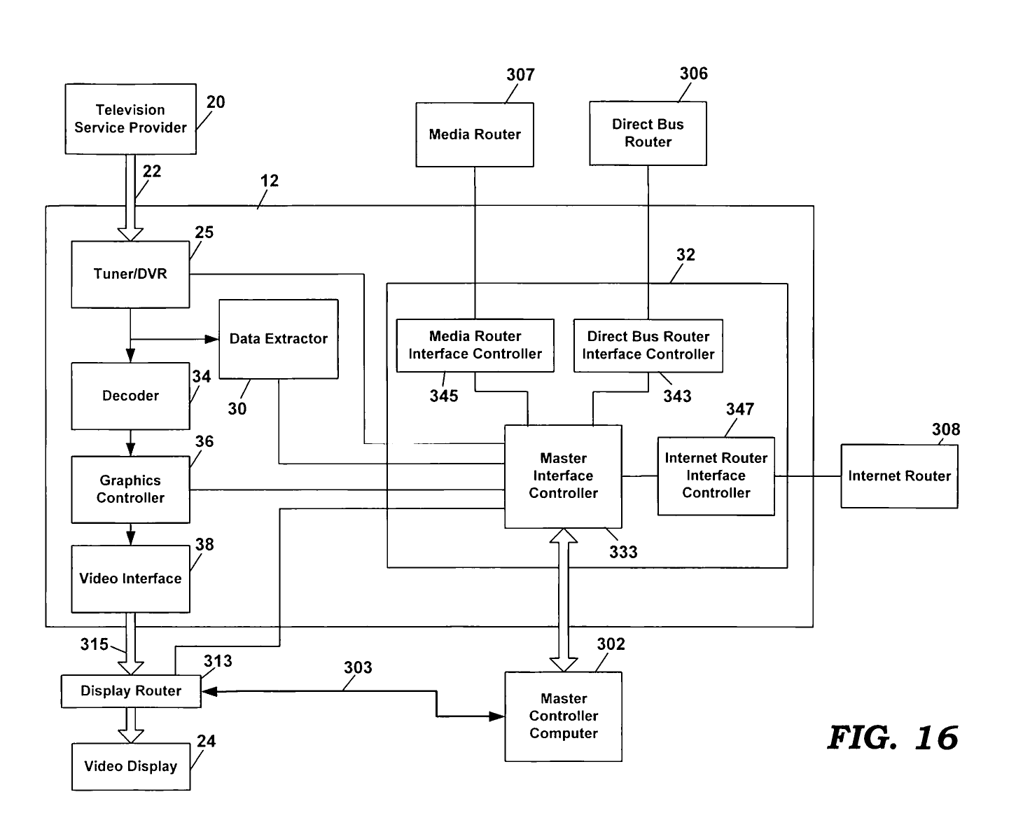

Further detail regarding the interface controller 32 of the TV/computer interface 12 is depicted in FIG. 16. The interface controller 32 may be described as consisting of four separate controllers: a master interface controller 333, a direct bus router interface controller 343, a media router interface controller 345, and an Internet router interface controller 347. The master interface controller 333 communicates with the MCC 302 directly over the main bus 303. The master interface controller 333 also receives information from the other interface controllers and distributes their data to the graphics controller 36 or the Tuner/DVR 25. The Internet router interface controller 347 functions in basically the same manner as the Ethernet controller 396 of the PC card 311, except that the controller 347 communicates with the master interface controller 333 rather than with a personal computer processor. The direct bus router interface controller 343 mediates the communication connection between the direct bus router 306 and the master interface controller 333. Similarly, the media router interface controller 345 mediates the communication connection between the media router 307 and the master interface controller 333. Although the interface controller 32 is represented as comprising four separate controllers, it will be appreciated that the controller 32 may consist of a single component performing the functions of the four different controllers described above. In a preferred embodiment, the media router interface controller 345 and the direct bus router interface controller 343 are also capable of performing the functions of the data extractor 30 as described above in extracting or copying user data from the digital media data stream.

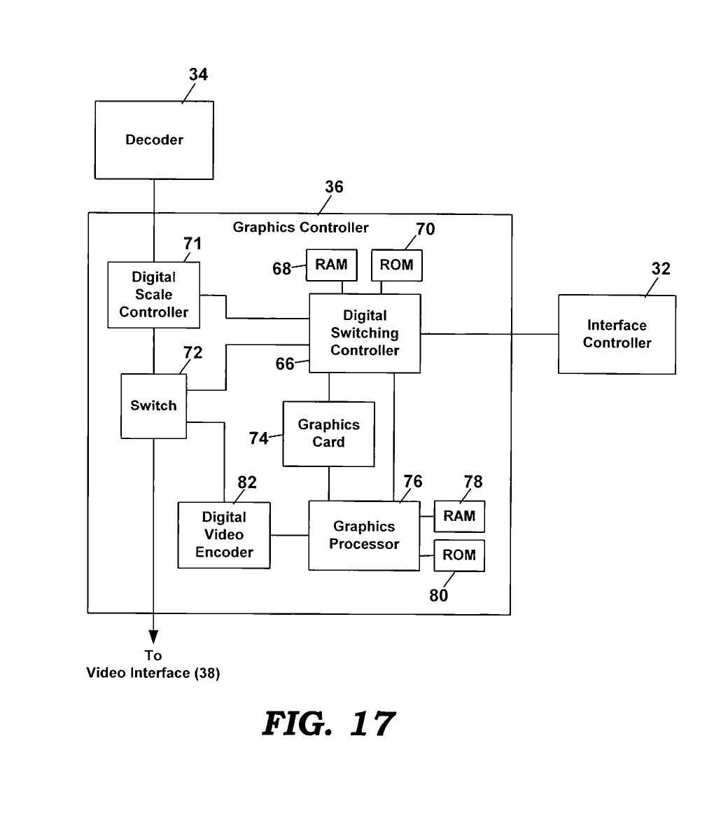

FIG. 17 depicts an alternative embodiment of the graphics controller 36 shown in FIG. 8. This embodiment includes a digital scale controller 71, which allows the user to adjust the display size of the digital signal from the decoder 34. With this feature, the user may change the digital TV signal to occupy one portion of a TV screen while displaying a recorded video signal or another TV channel on another portion of the screen.

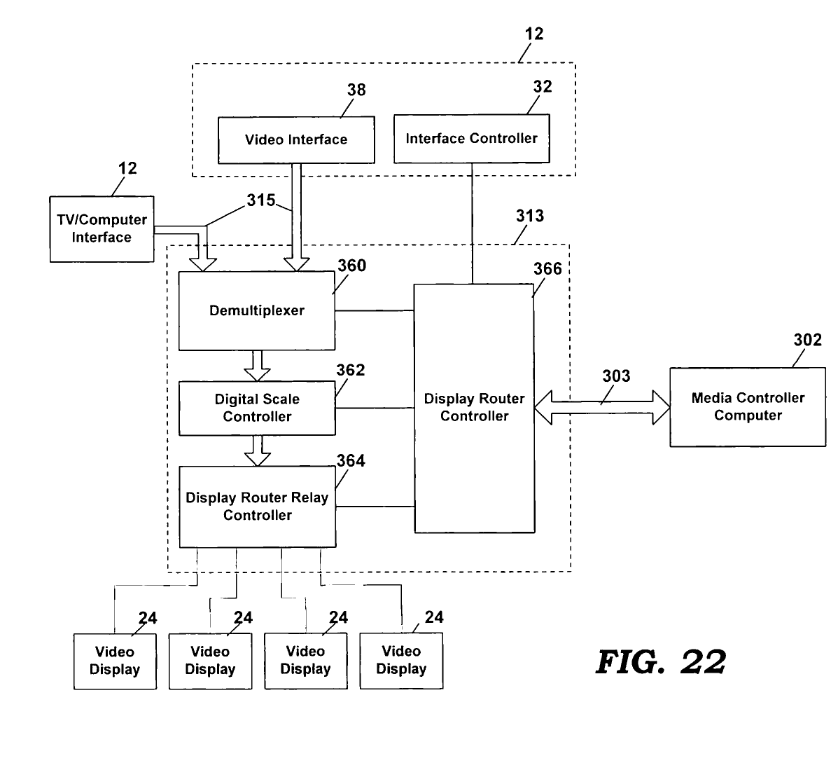

FIG. 22 depicts details of the display router 313 of a preferred embodiment of the invention. The display router 313 receives video information from the video interface 38 of one or more TV/computer interfaces 12 and routes the video information to any one or more of the multiple video display devices 24 distributed throughout a home or office. As discussed above, each TV/computer interface 12 is capable of decoding multiple digital video streams simultaneously, and multiplexing those streams on the display bus 315. The display router 313 includes a de-multiplexer 360 for receiving the multiplexed video streams and de-multiplexing those streams into individual streams for processing by a digital scale controller 362. The digital scale controller 362, which functions in much the same way as the digital scale controller 71 discussed above, scales the video streams so that multiple streams may be resized for display on a single display device. The display router 313 includes a display router relay controller 364 that controls the routing of the various video streams to the multiple display devices 24.

As shown in FIG. 22, the display router 313 includes a display router controller 366 which is in communication with the MCC 302 via the bus 303. In the preferred embodiment, the display router controller 366 controls the operation of the demultiplexer 360, the digital scale controller 362 and the display router relay controller 364. The display router controller 366 is also connected to the interface controller 32 of each TV/computer interface 12. The interface controller 32 provides information to the display router 313 regarding the characteristics of the video output from the TV/computer interface 12. For example, if the TV/computer interface 12 provides two overlaid signals, the interface controller 32 would relay that information to the display router 313. In this way, the display router 313 is able to distinguish the nature of the video output from the TV/computer interface 12 and correctly process the video output as two signals instead of processing it as one pure video signal.

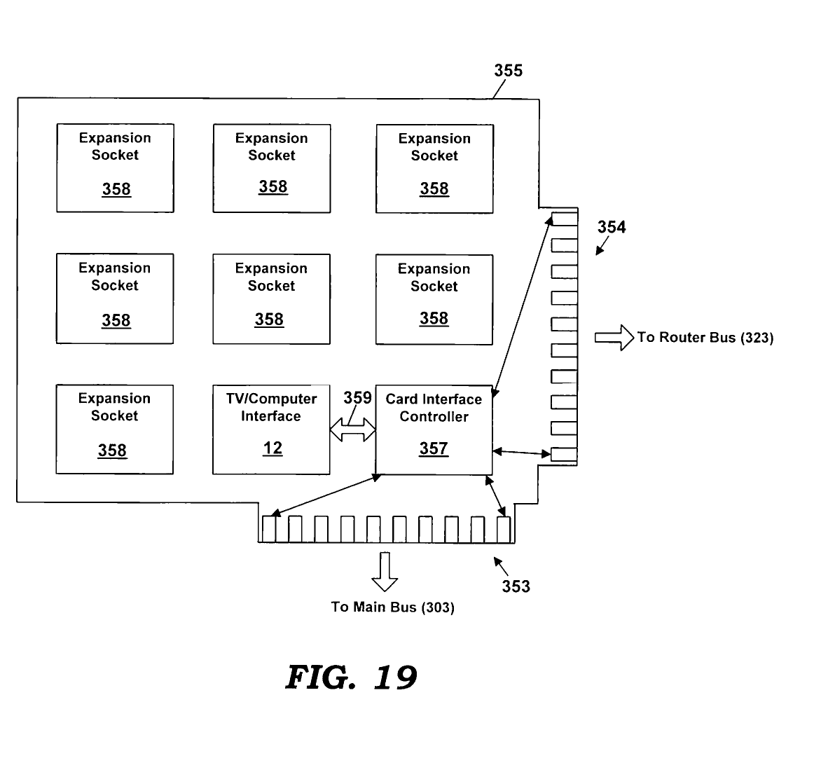

FIG. 19 depicts a system expansion card 355 according to a preferred embodiment of the invention. The expansion card 355 connects to the main bus 303 by way of a bus connect bar 353 and to the router bus 323 by way of a bus connect bar 354. Preferably, the connect bars 353 and 354 fit into slots in a main board of the system 300 in the same manner as a PCI card fits in an expansion slot of a desktop personal computer. In the embodiment of FIG. 19. the expansion card 355 includes an interface controller 357 which mediates communications between the components on the card 355 and components connected to the card 355 via the connect bars 353 and 354. In the preferred embodiment, the configuration of the bus bars 353 and 354 shown in FIG. 19 is standardized so that any manufacturer may produce expansion cards for use in the system 300.

The expansion card 355 may contain a single component, such as a single TV/computer interface 12 or a single PC 311, that connects directly to the main bus 303 as shown in FIGS. 14, 15 and 16. Alternatively, the expansion card 355 may itself be expandable by way of expansion sockets 358 as shown in FIG. 19. Using the expansion sockets 358, the capabilities of the card 355 may be expanded, such as by adding multiple TV/computer interface chips 12 for handling multiple audio/video outputs. The expansion sockets may also be used to add multiple PC chips 311, or to add other chips that enhance the performance of other components on the card 355. For example, a video accelerator chip may be added to enhance the graphics performance of the system.

In an embodiment wherein the expansion card 355 contains a single TV/computer interface 12, the interface controller 357 performs the functions of the interface controller 32 described above in reference to FIGS. 14 and 16.

The USB/Bluetooth network interface card 305 provides for communication with a wide array of wireless and wired control devices 18 and peripheral devices 19. The system 300 provides for multiple ways of connecting to the devices 18 and 19. For example, a home or office in which the system 300 is installed could be hardwired with USB connections to Bluetooth stations in multiple rooms or offices. Alternatively, the system 300 can accommodate wireless Bluetooth stations that relay information into the system 300. In another example, fiber optic cable could be routed throughout the home or office to transmit video output signals from the TV/computer interface cards 12 to the video display devices 24, and to transmit audio signals from the audio router 309 to the audio amplifiers/speakers 314. Wireless network connections, such as a wireless LAN, may also be used to connect the devices 18 and 19 to the system 300.

In a preferred embodiment of the system 300, the control device 18 is a Bluetooth-enabled headset or earpiece. This allows the user to control the system 300 using voice commands and step-through menus. In this embodiment, all of the audio signals may be provided to the headset or earpiece so that the user may receive phone calls, alerts, TV audio and music programming anywhere in the home or office.

The USB/Bluetooth network interface 305 may also communicate with peripheral devices 19 (FIG. 15), such as Bluetooth-enabled cellular phones, thereby providing a wireless interface between the system 300 and a user's phone. In this manner, as long as the user's cell phone is located in the home or office within communication range of the interface 305, the user may receive calls through the wireless headset or earpiece.

The USB/Bluetooth interface 305 provides for establishing communication with practically any Bluetooth-enabled peripheral device 19 within communication range of the interface 305. For example, a Bluetooth-enabled digital camera may upload photographs to the system 300 without having to be plugged directly into a computer. Alternatively, such peripheral devices 19 having USB interface connections may be plugged directly into a USB port connected to the interface 305. In preferred embodiments of the invention, updates to the programming of Bluetooth or USB devices 19 may be loaded via the interface 305 and controlled using menus displayed on a video display device 24 anywhere within the user's home or office.

In the preferred embodiment of the invention, the interface 305 is compatible with Bluetooth and USB communication protocols. However, it should be appreciated that the invention is not limited to any particular wireless or wired interface protocol. Alternative embodiments of the interface 305 support other communication protocols, such as Wi-Fi (IEEE 802.1a, 802.11b, 802.11g), WIMAX (IEE 802.16, 802.16a) and HyperLAN.

In further embodiments, the system 300 includes programming to utilize location coordinates from devices having Global Positioning System (GPS) receivers. For example, the system 300 may be used to download a coordinate “map” of the user's yard to a remote-controlled GPS-enabled lawn mower. GPS may also be used to locate devices within the user's home or office.

In one embodiment, the system 300 includes radio-frequency identification (RFID) tag readers disposed throughout a home or office. These readers may be used to determine the presence and location of RFID tagged devices and objects. The MCC 302 of this embodiment includes a software application for cataloging the tagged objects so that the user may pull up a list at any video display device 24 and determine the location of a tagged object.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A media control computer system for providing centralized access to and distribution of digital media content to multiple locations, the system comprising:
a main controller computer for controlling distribution of the digital media content based on input received from a user of the system;
one or more interface buses, at least one of which is connected to the main controller computer for communicating information to and from the main controller computer; and
one or more television/computer interface devices connected to at least one of the one or more interface buses and in communication with the main controller computer, each of the television/computer interface devices for receiving graphics information via the one or more interface buses and for generating a video signal based at least in part on the graphics information, the video signal in a format compatible for display on a television display device connected to the television/computer interface device.

2. The system of claim 1 further comprising a media center device connected to at least one of the one or more interface buses, the media center device for providing mass storage of the digital media content, the media center device including one or more original mass storage devices on which the digital media content is stored, the original mass storage devices selected from the group consisting of optical drives, magnetic hard drives and flash memory drives.

3. The system of claim 2 wherein the media center device includes one or more expansion locations for receiving one or more expansion mass storage devices, the expansion mass storage devices selected from the group consisting of optical drives, magnetic hard drives and flash memory drives, thereby providing for expandability of the media center to accommodate additional mass storage.

4. The system of claim 1 further comprising:
a personal computer device connected to at least one of the one or more interface buses, the personal computer device for executing software applications, generating the graphics information based on execution of the software applications and providing the graphics information to the television computer interface device via the one or more interface buses; and
one or more of the television/computer interface devices for receiving via the one or more interface buses the graphics information generated by the personal computer device and for generating the video signal based at least in part on the graphics information generated by the personal computer device.

5. The system of claim 1 further comprising:
a network interface device connected to at least one of the one or more interface buses, the network interface device for receiving control signals and providing control information to the main controller computer based on the control signals; and
one or more control devices for generating the control signals based on the input received from the user of the system, the one or more control devices further for communicating the control signals to the network interface device.

6. The system of claim 5 wherein:
the one or more control devices comprise one or more wireless control devices for generating wireless control signals based on the input received from the user of the system, the one or more wireless control devices further for wirelessly communicating the wireless control signals to the network interface device; and
the network interface device is for receiving the wireless control signals and providing control information to the main controller computer based on the wireless control signals.

7. The system of claim 6 wherein the one or more wireless control devices are selected from the group consisting of Bluetooth devices, Wi-Fi devices, WiMAX devices and HyperLAN devices.

8. The system of claim 5 wherein:
the one or more control devices comprise one or more Universal Serial Bus (USB) control devices; and
the network interface device comprises a USB interface.

9. The system of claim 5 further comprising:
one or more peripheral devices for generating the peripheral signals and communicating the peripheral signals to the network interface device; and
the network interface device for receiving the peripheral signals and providing peripheral information to the main controller computer based on the peripheral signals.

10. The system of claim 9 wherein:
the one or more peripheral devices include a digital camera having a Universal Serial Bus (USB) port, and the peripheral signals comprise digital photographs formatted as media data files; and
the network interface device comprises a USB interface for receiving the media data files and transferring the media data files across the one or more interface buses.

11. The system of claim 9 wherein:
the one or more peripheral devices comprise one or more wireless peripheral devices for generating wireless peripheral signals and for wirelessly communicating the wireless peripheral signals to the network interface device; and
the network interface device is for receiving the wireless peripheral signals and providing peripheral information to the main controller computer based on the wireless peripheral signals.

12. The system of claim 11 wherein the one or more wireless peripheral devices include a Bluetooth-enabled cellular phone.

13. The system of claim 1 further comprising a media router connected to at least one of the one or more interface buses, the media router for controlling routing of connections between components connected to the one or more interface buses.

14. The system of claim 4 further comprising a media router connected to at least one of the one or more interface buses, the media router for controlling routing of a connection between the personal computer device and the television/computer interface device.

15. The system of claim 1 further comprising an Internet router connected to at least one of the one or more interface buses, the Internet router for providing communication between the system and the Internet.

16. The system of claim 15 wherein the main controller computer further comprises a network interface for providing a direct communication connection between the main controller computer and the Internet router.

17. The system of claim 1 further comprising a direct bus router connected to at least one of the one or more interface buses, the direct bus router for routing direct connections between one or more media output devices and one or more media access devices under control of commands from the main controller computer, the direct bus router comprising:
a plurality of first connection ports for connecting to the one or more media output devices;
a plurality of second connection ports for connecting to the one or more media access devices;
switching means for connecting one or more of the first connection ports to one or more of the second connection ports.

18. The system of claim 17 wherein the media output devices include a media center, an audio router and one or more television/computer interface devices, and the media access devices include the media center, an Internet router and one or more personal computer devices.

19. The system of claim 17 wherein the switching means comprise:
a network of logic gates connected to the first and second connection ports and arranged in a tournament bracket configuration; and
a direct media gate controller for controlling the network of logic gates based on the commands from the main controller computer to control which of the first connection ports are connected to the second connection ports and which of the second connection ports are connected to the first connection ports.

20. The system of claim 1 further comprising an audio router connected to at least one of the one or more interface buses, the audio router for routing audio signals to one or more sets of audio speakers connected to the audio router, the routing of the audio signals controlled by control signals generated by the main controller computer and provided to the audio router via the one or more interface buses.

21. The system of claim 20 wherein the television/computer interface device generates the audio signals and communicates the audio signals to the audio router via an audio router bus.

22. The system of claim 1 further comprising:
the main controller computer for generating user interface screen graphics signals and for providing the user interface screen graphics signals at least one of the television/computer interfaces device via the one or more interface buses; and
the at least one television/computer interface device for receiving the user interface screen graphics signals and for generating the video signal based thereon, the video signal compatible with the television display device to generate user interface screen graphics on a video screen of the television display device, where the user interface screen graphics provide the user options for controlling the media control system.

23. The system of claim 1 wherein the one or more television/computer interface devices each include:
an interface controller for receiving graphics information from the one or more interface buses and generating a graphics information signal based on the graphics information;
a graphics controller for receiving a digital media data stream containing video data, for receiving the graphics information signal from the interface controller, for generating information window graphics based on the graphics information signal, and for combining the information window graphics with the video data from the digital media data stream to form the combination video signal in a format compatible for display on the television display device.

24. The system of claim 1 wherein
the one or more interface buses include one or more interface slots, and
the one or more television/computer interfaces are each disposed on one or more printed circuit cards operable to be inserted into the one or more interface slots of the one or more interface buses.

25. The system of claim 24 wherein
the one or more television/computer interface devices are provided in one or more semiconductor chips, and
the one or more printed circuit cards include one or more chip sockets thereon for receiving the one or more semiconductor chips.

26. The system of claim 25 wherein one or more of the printed circuit cards include expansion sockets for receiving expansion chips containing devices selected from the group consisting of television/computer interface devices and personal computer devices.

27. The system of claim 4 wherein
the one or more interface buses include one or more interface slots, and
the personal computer device is disposed on one or more printed circuit cards operable to be inserted into the one or more interface slots of the one or more interface buses.

28. The system of claim 27 wherein
the personal computer device is provided in one or more semiconductor chips, and
the printed circuit card includes one or more chip sockets thereon for receiving the one or more semiconductor chips.

29. The system of claim 1 further comprising a display router for receiving one or more video signals from the one or more television/computer interface devices and routing the one or more video signals to one or more television display devices.

30. The system of claim 29 wherein
at least one of the television/computer interface devices decodes multiple digital video streams and generates the video signal comprising the multiple digital video streams multiplexed together, and
the display router includes a de-multiplexer for receiving the video signal generated by the at least one television/computer interface device and for de-multiplexing the multiple digital video streams into individual video signals for display on the one or more television display devices.

31. The system of claim 1 wherein the one or more interface buses include a main bus.

32. The system of claim 1 wherein the one or more interface buses include a display bus.

33. The system of claim 1 wherein the one or more interface buses include a router bus.

34. A media control computer system for providing centralized access to and distribution of digital media content to multiple locations, the system comprising:
a main controller computer for controlling distribution of the digital media content based on input received from a user of the system;
one or more interface buses, at least one of which is connected to the main controller computer for communicating information to and from the main controller computer;
a media center device connected to at least one of the one or more interface buses and in communication with the main controller computer, the media center device for providing mass storage of the digital media content, the media center device including one or more mass storage devices on which the digital media content is stored, the mass storage devices selected from the group consisting of optical drives, magnetic hard drives and flash memory drives;
a personal computer device connected to at least one of the one or more interface buses and in communication with the main controller computer and the media center via the one or more interface buses, the personal computer device for accessing the digital media content stored at the media center, for executing software applications to process the digital media content, and for generating graphics information based on execution of the software applications; and
one or more television/computer interface devices connected to at least one of the one or more interface buses and in communication with the main controller computer and the personal computer device, each of the television/computer interface devices for receiving the graphics information generated by the personal computer device and for generating a video signal based at least in part on the graphics information generated by the personal computer device, the video signal in a format compatible for display on a television display device connected to the television/computer interface device.

35. A media control computer system for providing centralized access to and distribution of digital media content to multiple locations, the system comprising:
a main controller computer for controlling distribution of the digital media content based on input received from a user of the system;
one or more interface buses, at least one of which is connected to the main controller computer for communicating information to and from the main controller computer;
one or more television/computer interface devices connected to at least one of the one or more interface buses and in communication with the main controller computer, each of the television/computer interface devices for receiving graphics information via the one or more interface buses and for generating a video signal based at least in part on the graphics information, the video signal in a format compatible for display on a television display device connected to the television/computer interface device;
a media center device connected to at least one of the one or more interface buses for providing mass storage of the digital media content, the media center device including one or more original mass storage devices on which the digital media content is stored, the original mass storage devices selected from the group consisting of optical drives, magnetic hard drives and flash memory drives;
a personal computer device connected to at least one of the one or more interface buses, the personal computer device for executing software applications, generating the graphics information based on execution of the software applications and providing the graphics information to the television computer interface device via the one or more interface buses;
a network interface device connected to at least one of the one or more interface buses, the network interface device for receiving control signals and providing control information to the main controller computer based on the control signals;
one or more control devices for generating the control signals based on input received from the user of the system, the one or more control devices further for communicating the control signals to the network interface device;
a media router connected to at least one of the one or more interface buses, the media router for controlling routing of connections between the personal computer device, the television/computer interface device and the media center device; and
an Internet router connected to at least one of the one or more interface buses, the Internet router for providing communication between the system and the Internet.
